(19) United States
(12) Patent Application Publication
(10) Pub. No.: US 2003/0228004 A1
(43) Pub. Date: Dec. 11, 2003

(54) Method for generating a telephone number

(76) Inventor: Werner Rupp, Bad Vilbel (DE)

Correspondence Address: KIRK DOBBINS, 5625 DESOTA SUITE 5100, HOUSTON, TX, 77091

(21) Appl. No.: 10/333,347

(22) PCT Filed: Jul. 14, 2001
(86) PCT No.: PCT/DE01/02635

(30) Foreign Application Priority Data
Jul. 20, 2000 (DE) 100 35 217.0

(51) Int. Cl. H04M 1/00; H04M 1/64

(52) U.S. Cl. 379/88.17; 379/355.01

(57) ABSTRACT

A method of generating a telephone number permits a symbol representing a telephone number to be activated, the symbol corresponding to a hyperlink or the input of the telephone number as text.

### BACKGROUND INFORMATION

The present invention is directed to a method of generating a telephone number according to the definition of the species in the main claim. Data processing systems capable of running applications which permit a user of the data processing system to generate a telephone number by activating a button programmed on a screen mask using a mouse, for example, are known in general.

### ADVANTAGES OF THE INVENTION

The method according to the present invention having the features of the main claim has the advantage over the related art that the symbol whose activation causes the telephone number to be generated is very easily generated or created. Thus even an inexperienced user of a data processing system is capable of generating symbols or general images whose activation causes a telephone number to be generated and is not obligated to use the services of an experienced computer user (programmer) just for generating such symbols.

It is furthermore advantageous that the hyperlink is a standard hyperlink, which further simplifies the method according to the present invention, because the functions provided in standard data processing applications in particular may also be used for generating a standard hyperlink.

It is furthermore advantageous that the hyperlink includes an identifier for generating telephone numbers. This permits the user of the data processing system to immediately recognize, for a hyperlink in general, whether this is a hyperlink specifically created for generating a telephone number (phone hyperlink).

It is furthermore advantageous that the identifier includes the word “phone.” In this way, reference is made, via the identifier, to the function which triggers the activation of the hyperlink, namely, the generation of a telephone number.

It is furthermore advantageous that activating the hyperlink corresponds to selecting by pressing an input button of an input device at least once, which permits the hyperlink to be rapidly and easily activated.

It is furthermore advantageous that the input device is a mouse and the input button is a mouse button. This makes a particularly simple operation of the data processing application for generating telephone numbers possible, because the user normally operates the data processing application mostly by operating a mouse as an input device.

It is furthermore advantageous that the activation of the symbol for generating the telephone number corresponds to the input of specific information. This makes particularly fast and reliable activation of the symbol possible, in particular when the symbol is created by entering the telephone number as text, because the specific information almost completely prevents input errors or misinterpretations.

It is furthermore advantageous that the specific information corresponds to the actuation of a function key, which provides particularly simple operation.

It is furthermore advantageous that the data processing application is a standard program for use with data processing systems, which makes the method according to the present invention broadly usable, while compatibility problems are largely limited.

### DRAWING

An exemplary embodiment of the present invention is illustrated in the drawing and elucidated in detail in the description that follows.

FIG. 1 shows a first exemplary configuration for the integration of a telephone with a data processing system;

FIG. 2 shows a second exemplary configuration for the integration of a telephone with a data processing system; and

FIG. 3 shows a schematic flow chart of an exemplary implementation of the method according to the present invention.

### DESCRIPTION OF THE EXEMPLARY EMBODIMENT

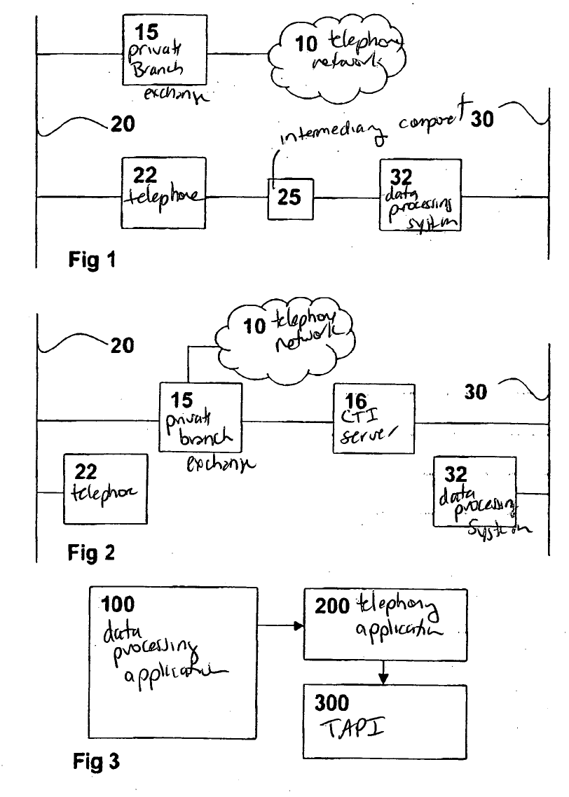

FIG. 1 shows a first exemplary configuration of the interaction between a data processing system and a telephone. A telephone 22 is connected to a private branch exchange 15 via a telephone network 20. Private branch exchange 15 is in turn connected to an external telephone network 10, in particular the public telephone network 10. Furthermore, a data processing system 32 is connected to a data network 30. Data processing system 32 includes a display device (not illustrated) and an input means (not illustrated), in particular input devices such as a mouse, a keyboard, and the like. Data network 30 is an internal network in particular, for example, a LAN (Local Area Network). Data network 30 is connected according to the present invention in particular to other networks (not illustrated), for example, the Internet, via components which are also not illustrated. To run telephony applications on data processing system 32, it is necessary that data processing system 32 communicate with telephone 22 or private branch exchange 15. This is accomplished in the first exemplary configuration using an intermediary component 25, which is connected to both telephone 22 and data processing system 32. According to the present invention, intermediary component 25 is an interface adapter in particular. The first exemplary configuration largely corresponds to a “first-party architecture” of CTI (Computer Telephony Integration) implementations. Obviously, both telephone 22 and data processing system 32 represent a plurality of such components.

FIG. 2 shows a second exemplary configuration of the interaction between a data processing system and a telephone. Essentially, this is a third-party architecture of a CTI implementation. Also in this case, telephone 22 is connected to private branch exchange 15 via telephone network 20, while private branch exchange 15 is in turn connected to external telephone network 10. Data processing system 32 is in turn connected to data network 30. In contrast with a first-party architecture, however, in this case telephone 22 and data processing system 32 are not directly connected, but via telephone network 20, private branch exchange 15, and data network 30. A CTI server 16 is provided for this purpose between data network 30 and private branch exchange 15. CTI server 16 is thus connected to both private branch exchange 15 and data network 30. Control data and useful data to be transmitted from a telephony application running on data processing system 32 to telephone 22 are transmitted, over the path including data network 30, CTI server 16, private branch exchange 15, and telephone network 20, to telephone 22, where the control data and useful data received are converted as would be the action performed by the user of the data processing application on data processing system 32, i.e., dialing a node, call-back, storing a telephone number in the telephone directory, or the like, for example, by the user on telephone 22.

FIG. 3 shows a schematic flow chart of an exemplary implementation of the method according to the present invention. A data processing application 100 provides the possibility of creating or generating a hyperlink, for example, in a text document or an Internet document (e.g., in HTML format). In standard data processing applications, in word processing programs in particular, this is accomplished, for example, by providing an “Insert hyperlink” function, which can always be selected by the user whenever a document created by the user is to contain one or more hyperlink(s). When viewing such a document containing (a) hyperlink(s), the hyperlinks are usually in color, underscored, or made recognizable in some other way, so that the user, who may not necessarily be the same as the author of the document, is able to recognize the hyperlink without difficulty. Such a hyperlink is activated according to the present invention by pressing an input button of an input device at least once. This is accomplished according to the present invention by the fact that data processing system 32 includes a mouse as an input device and the user of data processing system 32 then positions the cursor that appears on the display device of the data processing system on the hyperlink and activates it by pressing a mouse button.

According to the present invention, a hyperlink includes an identifier which signals to data processing application 100 that a telephone number is to be generated by the activation of the hyperlink. Subsequently, data processing application 100 forwards the information that the hyperlink has been activated to a telephony application 200. Telephony application 200 processes the information received from data processing application 100 so that an instruction to generate a telephone number is transmitted to a TAPI (Telephony Application Programming Interface) 300, which further processes the instruction until the telephone number is generated by telephone 22 or private branch exchange 15.

In an advantageous embodiment, telephony application 200 may also monitor all the information that is generated by data processing application 100 as a result of a hyperlink having been activated. This may include either hyperlinks provided for generating a telephone number or hyperlinks provided for other purposes, for-example, for accessing a web site. In the second embodiment, the identifier of the hyperlink, which indicates that the hyperlink is provided for generating a telephone number, is not recognized in data processing application 100, but in telephony application 200. As in the first embodiment, telephony application 200 generates an instruction to TAPI 300 to generate the telephone number.

If the symbol is not a hyperlink, but only an input text which includes the telephone number, the appropriate text block is essentially selected in data processing application 100 and the information about the telephone number is relayed, for example, by actuating a function key, to telephony application 200, which in turn relays the instruction for generating this telephone number to TAPI 300. Telephony application 200 is embodied, in particular, as CTI software, which makes a dialable number out of the string of the telephone number transmitted via the hyperlink or the text. Generating a symbol representing the telephone number is convenient, in particular, in the following cases according to the present invention: inserting telephone numbers in the automatic signature of e-mail messages, inserting telephone numbers in the headers of letters, inserting telephone numbers in Internet documents (HTML files), or inserting telephone numbers in telephone directory applications.

What is claimed is:

1. A method of generating a telephone number using a data processing application (100) capable of running on a data processing system (32), by activating a symbol displayed on a display device associated with the data processing system (32) and representing the telephone number, the following steps being executed:
the symbol is created;
the symbol is activated,
wherein
creating the symbol corresponds to creating a hyperlink, and activating the symbol corresponds to activating the hyperlink; or
creating the symbol corresponds to inputting the telephone number as a text, and activating the symbol corresponds to selecting the text which denotes the telephone number, and the subsequent activation corresponds to generating the telephone number.

2. The method as recited in claim 1,
wherein the hyperlink is a standard hyperlink.

3. The method as recited in one of the preceding claims,
wherein the hyperlink includes an identifier for generating telephone numbers.

4. The method as recited in claim 3,
wherein the identifier includes the word “phone.”

5. The method as recited in one of the preceding claims,
wherein activating the hyperlink corresponds to selecting by pressing an input button of an input device at least once.

6. The method as recited in claim 5,
wherein the input device is a mouse and the input button is a mouse button.

7. The method as recited in claim 1,
wherein the activation of the symbol for generating the telephone number corresponds to the input of specific information.

8. The method as recited in claim 7,
wherein the specific information corresponds to the actuation of a function key.

9. The method as recited in one of the preceding claims,
wherein the data processing application (100) is a standard program for use with data processing systems (32).
